(19) United States
(12) Patent Application Publication
(10) Pub. No.: US 2020/0226704 A1
(43) Pub. Date: Jul. 16, 2020

(54) SYSTEMS AND METHODS FOR MANAGING SCHOLARSHIPS USING A DONOR INTERFACE

(71) Applicant: Lisa Watson, Kansas City, KS (US)

(72) Inventor: Lisa Watson, Kansas City, KS (US)

(21) Appl. No.: 16/741,451

(22) Filed: Jan. 13, 2020

Related U.S. Application Data
(60) Provisional application No. 62/792,088, filed on Jan. 14, 2019.

(51) Int. Cl. G06Q 50/20; G06Q 30/02; G09B 5/06; G09B 7/02

(52) U.S. Cl. CPC G06Q 50/2053; G09B 7/02; G09B 5/06; G06Q 30/0279

(57) ABSTRACT

A system for managing scholarships comprises a database including scholars, a donor interface, and a payment module. Each scholar in the database is associated with a school using a student identification number. The donor interface is configured to display a list of the scholars from the database based on criteria selected by a donor. The donor interface is also configured to select at least one of the scholars and generate a scholarship for the selected scholar. The amount of each scholarship is associated with a task. The task relates to a topic selected by the donor. The payment module is configured to receive payment from the donor to fund the scholarship and provide payment to the school when the task associated with the scholarship has been completed.

### CROSS-REFERENCE TO RELATED APPLICATIONS

This application claims priority to U.S. Provisional Patent Application Ser. No. 62/792,088, filed Jan. 14, 2019, the entire contents and disclosure of which is hereby incorporated by reference in its entirety.

### BACKGROUND

The field of the disclosure relates generally to systems for managing scholarships, and, more specifically, to a system that allows a donor to provide a scholarship to a recipient and associate the scholarship with completion of a selected task.

A society's education system provides for the education of citizens to prepare citizens for educated roles in the society and ensure the society functions properly. Societal problems including poverty, increased crime rates, increased dependency on social services, increased substance abuse rates, and higher incarceration rates are at least partially caused by schools that do not adequately educate the citizenry, i.e., failing schools. To provide adequate education, schools should educate children and develop skills that teach children how to lead independent and self-directed lives. Accordingly, taxpayers and the government fund public schools which the government operates. However, the public schools may not have adequate funding and the number of children attending the public schools may prevent the public schools from providing the highest quality education for each child.

Some children attend private schools which may provide better education and/or opportunities than public schools. The private schools often provide opportunities such as specialized care and instruction, advanced placement, better resources, lower student to teacher ratios, religious and moral instruction, extracurricular activities, better facilities than public schools, increased career and college placement opportunities, mentoring opportunities, and many more opportunities. In addition, private schools have increased flexibility in teaching styles, curriculum opportunities, and parental involvement. However, children with lower financial resources may be trapped in failing schools and may not have the option to pursue education at private schools. For example, at least some children who would prefer to attend private schools are unable to attend because they are unable to pay tuition. In areas with dense populations such as urban areas, the disparity between education opportunities for people with different income levels may be exacerbated because the public schools are filled beyond their capacities and the private schools have a higher demand resulting in higher costs.

Currently, the demand for private scholarships to attend schools providing grades K-12 education far exceeds the available funding. Accordingly, some private schools offer scholarships via lottery systems in which only a small percentage of the eligible children requesting scholarships actually receive scholarships. Other private schools offer scholarships to the first designated number to apply. Still further schools award scholarships based on a random selection from among all qualified applicants. Sometime, donors provide merit based scholarships. However, some scholarships may not be earned by students because the school may not be able to identify any qualified applicants that meet donor requirements. As a result, many children that aspire to attend private schools do not receive scholarships. Accordingly, many families obtain loans and incur other forms of debt to be able to afford tuition for private schools.

Current methods for creating and funding private scholarship programs are cumbersome and expensive. For example, potential donors must establish a budget, develop criteria for the recipients, complete administrative forms, market the scholarship to the public, pay administrative fees, require potential applicants or their legal guardians to complete extensive applications, establish an evaluation committee, evaluate applications, select recipients, and distribute funds to the recipients and/or the recipients' school. However, even after completing the due diligence and awarding scholarships, donors have no mechanism to measure the impact of their funding. Accordingly, current methods for creating private scholarship programs are time-consuming, expensive, and fail to provide feedback to donors about the impact of their awards.

Therefore, there is a need for a platform that matches donors with prequalified students, eliminates cumbersome paperwork for donors and recipients, allows donors to create micro-scholarships for a fraction of the cost of traditional scholarships, eliminates administrative fees, allows donors to both evaluate and select scholarship recipients, requires parents to complete an accountability assignment prior to distribution of the scholarship, and distributes the funds in a single transaction.

### BRIEF DESCRIPTION

In one aspect, a system for managing scholarships comprises a database including scholars, a donor interface, and a payment module. Each scholar in the database is associated with a school using a student identification number. The donor interface is configured to display a list of the scholars from the database based on criteria selected by a donor. The donor interface is also configured to select at least one of the scholars and generate a scholarship for the selected scholar. The amount of each scholarship is associated with a task. The task relates to a topic selected by the donor. The payment module is configured to receive payment from the donor to fund the scholarship and provide payment to the school when the task associated with the scholarship has been completed.

In another aspect, a method for managing scholarships includes displaying a list of scholars from a database of scholars. Each scholar is associated with a school. The method also includes selecting, using a donor interface, at least one scholar from the database of scholars and generating a scholarship for the selected scholar. An amount of the scholarship is selected by a donor. The method also includes receiving, using a payment module, payment from the donor to fund the scholarship. In some embodiments, the method further includes associating a task with the scholarship. The task relates to a topic selected by the donor. The method further includes providing payment to the school when the task associated with the scholarship has been completed.

In a further aspect, a method for creating a scholarship includes selecting a student from a database of pre-qualified students using a donor interface including at least one photograph and information relating to each student. The database associates each scholar with a school and a student identification number. Using the donor interface, the donor selects an accountability task from a list of topics. Each accountability task is associated with a scholarship amount. The scholarship amount is funded using the payment module. The method also includes associating the scholarship with the student identification number and the completion of the task. The method further includes providing the accountability task to a family of the selected scholar using a scholar interface. The scholar interface provides a due date for completion of the accountability task and the family of the selected scholar is required to complete a quiz associated with the accountability task. The method also includes notifying the donor upon completion of the accountability task. The donor is allowed to provide feedback including a review and a rating. The method further includes depositing, using a banking interface, scholarship funds in an account associated with the school and associating the deposited funds with the student identification number using the banking interface.

### BRIEF DESCRIPTION OF THE DRAWINGS

FIG. 1 is a block diagram of a system including a donor interface;

FIG. 2 is an illustration of a website for use with a system for managing scholarships, such as the system shown in FIG. 1, the website including the donor interface, a scholar/guardian interface, and a school interface; and

FIG. 3 is another illustration of the website shown in FIG. 2.

### DETAILED DESCRIPTION

As used herein, an element or step recited in the singular and preceded with the articles “a”, “an”, “the” and “said” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features. The terms “comprising”, “including” and “having” are intended to be inclusive and mean that there may be additional elements other than the listed elements.

The present disclosure provides systems and methods for managing scholarships. Embodiments include a searchable database of scholars and a donor interface. The donor interface allows the donors to select a scholar and generate a scholarship for the scholar. The donor may assign a specific task to the scholar for completion before receipt of the scholarship. The assigned task may include a lesson and/or quiz. The task may be assigned to the scholar and/or a designated responsible person such as a parent or guardian. Upon completion of the task, the donor may be able to review a report and acknowledge completion. Then, payment is sent to a school attended by the scholar and the amount of the scholarship is deducted from tuition owed by the scholar. Accordingly, the described systems and methods allow scholars to crowdsource and earn at least a portion of their tuition. In addition, the donor is able to provide customized scholarships to individual scholars. Moreover, the scholars are accountable to the donors and the donors receive reports about the scholar's completion of a task required to receive the scholarship. The donor interface allows a donor to select a student, evaluate the student, select an accountability task, and fund a micro-scholarship in a single transaction.

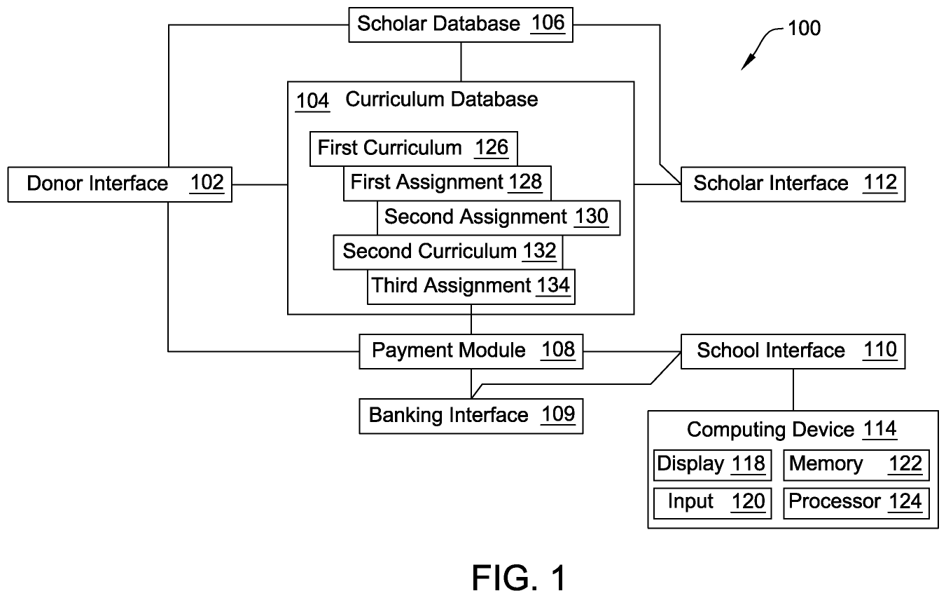

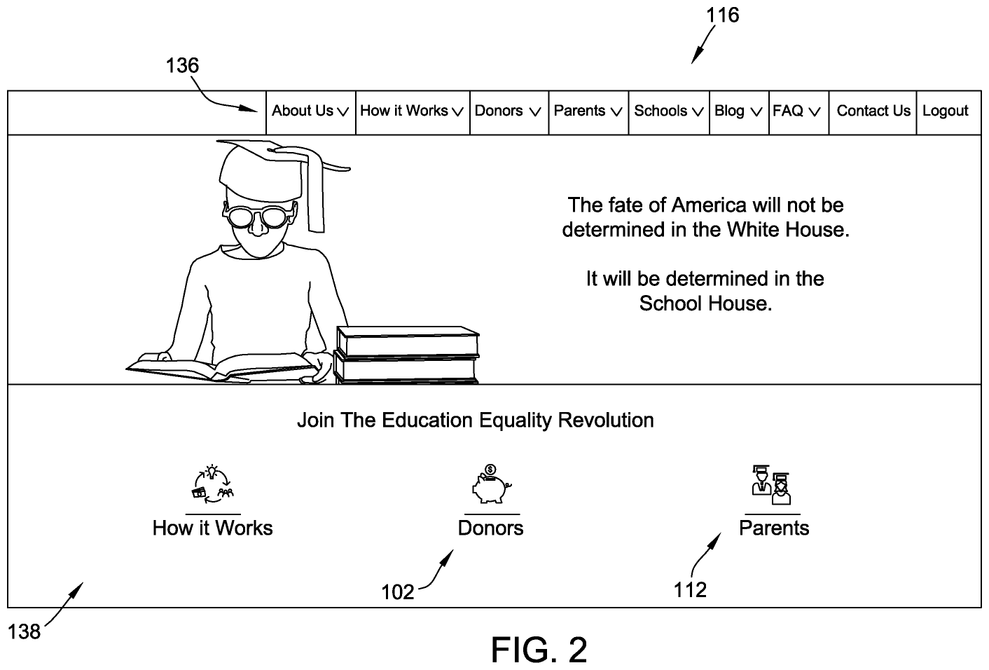

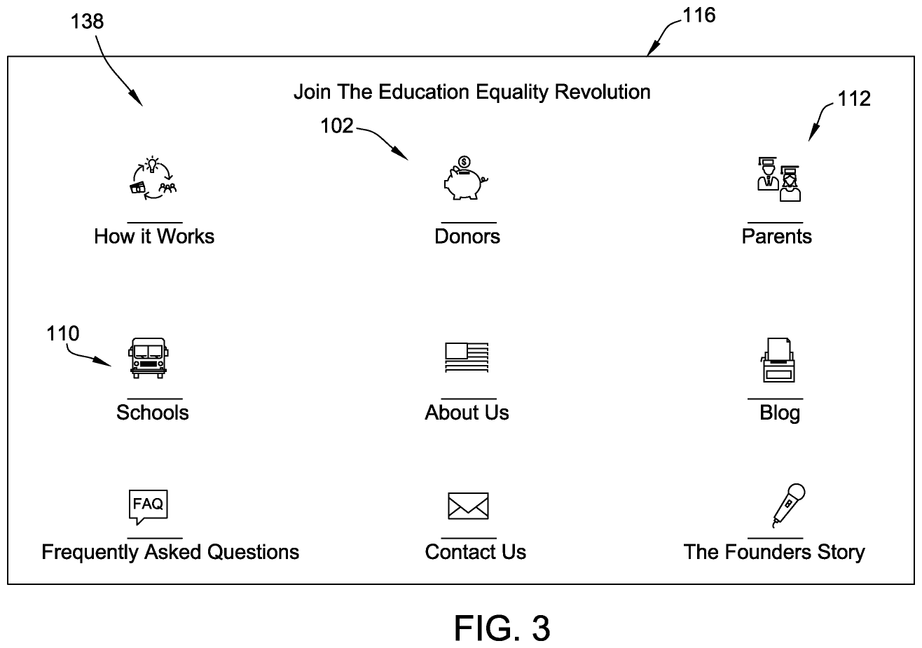

FIG. 1 is a block diagram of an exemplary system 100 for managing scholarships. System 100 includes a donor interface 102, a curriculum database 104, a scholar database 106, a payment module 108, a school interface 110, and a scholar or guardian interface 112. In addition, system 100 may include one or more computing devices 114. The computing device 114 may include a display 118, an input 120, a memory 122, and/or a processor 124. For example, the computing devices 114 may be, without limitation, a desktop computer, a laptop computer, a tablet, a cell phone, a server, a “smart” appliance including a processor, and any other suitable computing device. Any of the donor interface 102, curriculum database 104, scholar database 106, scholar interface 112, payment module 108, and/or school interface 110 may be stored on and/or accessible using computing device 114. For example, the donor interface 102, curriculum database 104, scholar database 106, scholar interface 112, payment module 108, and/or school interface 110 may be included on a website 116 (shown in FIGS. 2 and 3) accessible using any computing device 114.

Each of the donor interface 102, the scholar interface 112 and the school interface 110 may include account information, such as a login name and a password, for a respective user. The user may be required to register and provide personal information prior to using the donor interface 102, the scholar interface 112 and/or the school interface 110. In some embodiments, the identity of the user must be verified prior to using the respective interface. The scholar interface 112 may be used by a guardian of a scholar. In some embodiments, the guardians and the scholars have separate accounts. In other embodiments, only one of the guardian and the scholar has an account. Suitably, the guardian is able to use the scholar interface 112 and the guardian is encouraged to participate in the education of the scholar. In addition, the guardians may receive valuable lessons through completing the tasks as described later. Moreover, the guardian may be the party responsible for the tuition because the scholar may be a minor and, thus, will be required to pay any portion of the tuition that is not earned through scholarships. In some embodiments, the scholar may not necessarily have a guardian and the scholar or another party acting on behalf of the scholar is able to utilize the scholar interface 112.

The scholar database 106 includes scholars, e.g., students or potential students, who are interested in receiving scholarships to cover at least a portion of tuition at a private school. As used herein, the phrase “private school” refers to a school that receives at least a portion of its funding from and is operated by a private organization(s) and/or an individual(s). Such private schools may require payment, i.e., tuition, from scholars to allow the scholars to attend the school. Some scholars may be unable to afford tuition and, therefore, be denied admittance into a private school. To raise money for tuition, the scholars may search for scholarships. However, it may be difficult for the scholars to reach and make connections with individuals willing to donate money. The scholar database 106 allows the scholars an opportunity to present information to potential donors. Accordingly, the scholar database 106 simplifies the scholars' search for scholarships because the scholars are not required to individually search out and recruit donors. Moreover, the system 100 allows scholars and/or a guardian to complete a task to earn the scholarships when selected from the scholar database 106.

The scholars may apply for and/or be selected for inclusion in the scholar database 106. The scholar interface 112 may allow the scholars to apply for inclusion in the scholar database 106. Each scholar in the scholar database is assigned a student identification number. In some embodiments, the scholars may be required to pay a one-time or recurring fee to be included in the scholar database 106. Requiring payment from the scholar ensures that the scholar is invested in the process and increases the chances of a successful match between the scholar and the donor. The payment may be based on the financial means of the scholar and/or of the scholar's guardian. In some embodiments, at least a portion of the payment may be waived. In further embodiments, payment is not required from any scholars.

The scholar database 106 may include any number of scholars and may include information on each scholar. The information may be received from the scholar, obtained from public records, obtained from social media, and/or recorded by the system 100 based on the scholar's participation in the system 100. The information may include biographical information, pictures, videos, reviews, statistics, scores, and any other information relating to and/or provided by the scholars. The scholars in the scholar database 106 may be sortable based on any available categories such as age, sex, race, religion, school, location of residence, family situation, financial need, duration of inclusion in the scholar database, participation in the scholar database, received scholarships, tuition needs, extracurricular interests, educational scores, and educational goals.

Each scholar may be related to one or more schools. The related school(s) may be a school that the respective scholar is attending and/or a school that the scholar is interested in attending. The system 100 may include a plurality of different schools or may be specific to a single school. The schools may apply to be included and may be required to pay a fee. The fees provided by the schools helps cover the costs associated with operation of the system 100 and allows a greater amount of the donations to be applied directly to the scholar's tuition. For example, the operating costs for the system 100 may be covered entirely by the fees received from the schools and/or the scholars such that 100% of donations from the donors may be applied to the scholarships.

The donor interface 102 is configured to allow a donor to select at least one of the scholars from the scholar database 106. The donor may use the donor interface 102 to browse the scholars and discover any information related to the scholars. Accordingly, the scholar database 106, the scholar interface 112, and the donor interface 102 may allow the scholars to “market” themselves and provide information which could attract attention of the donors. For example, the scholars may provide pictures, videos, and messages for potential donors to entice the donors to select the scholar. After viewing the scholars, the donors may select one or more of the scholars. Optionally, the donor may be automatically matched with a potential scholar randomly or based on criteria designated by the donor. Once a donor selects a scholar, the donor interface 102 is configured to allow a donor to generate a scholarship. In some embodiments, the donor interface 102 may allow the donor to generate a scholarship without selecting a specific scholar.

The donor interface 102 may allow the donor to locate and select a specific friend and/or relative. Accordingly, the donor interface 102 may facilitate “gifting” scholarships to friends and relatives. For example, the donor may give a scholarship to a scholar instead of a traditional gift or money on a special occasion. Optionally, the donor interface 102 may allow the donor to input a message or indicate that the scholarship is a gift. In addition, the donor interface 102 may provide an electronic or paper certificate for the donor to provide to the recipient. Sometimes, the scholar may not necessarily be active on the scholar database 106 prior to the gift and the donor or donor interface 102 may provide instructions to the scholar on how to claim and earn the scholarship. In some embodiments, the scholar may choose to request gifts on the system 100 from friends and family. For example, the scholar may enter a special occasion such as a birthday or graduation and send notifications to friends and/or relatives that a scholarship of any amount is requested in lieu of a traditional gift. Accordingly, the system 100 recognizes and encourages the roles of family and community in the education of scholars and enables all parties to be more actively involved in the education process.

Suitably, the donor interface 102 allows the donor to customize the scholarship. For example, the donor may be able to select an amount for the scholarship. In some embodiments, the system 100 may require a minimum amount for the scholarship. For example, the system 100 may require that the scholarship be at least $5, at least $10, or at least $20. Notably, the scholarships may be substantially less than typical scholarships. Accordingly, the system 100 is specifically configured to allow for “micro-scholarships”, e.g., scholarships that cover only a fraction of tuition. For example, the system 100 aggregates administrative costs to allow more donors to donate scholarships. In some embodiments, the donor interface 102 may provide preset scholarships for a donor to select. The system may offer preset micro-scholarships that are less than $1,000 or less than $100.

In addition, the donor interface 102 allows the donor to associate a task with the scholarship. For example, the task may be a lesson or assignment selected from the curriculum database 104. The curriculum database 104 may include at least one curriculum having at least one assignment. For example, the curriculum database 104 may include a first curriculum 126 having a first assignment 128 and a second assignment 130. The curriculum database 104 may also include a second curriculum 132 having a third assignment 134. The assignments 128, 130, 134 may include videos, presentations, literature, interactive learning modules, and any other informative materials. For example, the curriculum database 104 may include at least fifteen curriculums. Each curriculum 126, 132 may include assignments 128, 130, 134 that relate to a specific topic. For example, each curriculum may be designed to teach life skills, instruct moral or religious values, provide career training, and/or provide any other suitable information. The curriculum 126, 132 and/or assignments 128, 130, 134 may be stored on the memory 122, generated based on preset criteria, and/or customized by the donor.

The assignments 128, 130, 134 may be designed to provide information to and/or teach the person completing the assignment. The donor may require the selected scholar to complete a specific assignment 128, 130, 134, to complete any assignment 128, 130, 134 from a specific curriculum 126, 132, or to complete any available assignment 128, 130, 134. The scholar database 106 may track the assignments 128, 130, 134 completed by the scholar and such information may be provided to the donor. In addition, if the scholar has previously completed a selected assignment 128, 130, 134, the system 100 may provide a related or subsequent assignment 128, 130, 134 for completion by the scholar.

The scholar interface 112 is configured to allow the scholar and/or a responsible party, such as a guardian of the scholar, to complete the assignment 128, 130, 134. For example, the scholar and/or guardian may watch a video, read literature, and/or review a presentation included in the assignment 128, 130, 134. The scholar and/or guardian may then be required to complete a quiz and/or provide information based on the content of the assignment 128, 130, 134. In the example, the quiz is a five-point quiz and is configured to certify that the scholar and/or guardian completed the assignment 128, 130, 134 and not necessarily to test knowledge. The quiz may include multiple choice questions, short answer questions, and/or open-ended essay questions.

A copy of the accountability task and completed quiz is sent to the donor when the assignment 128, 130, 134 has been completed. The donor may review the report and certify that the assignment 128, 130, 134 has been satisfactorily completed. In the example, the donor has an option to provide brief feedback on the answers to the quiz. The quiz questions are designed to solicit subjective, rather than objective responses. The donor is encouraged to rate the quality of the quiz responses using a rating system of 1-5 stars.

The system 100 may require that the scholar completes any assignment 128, 130, 134 within a designated time after the scholar is notified of the assignment. For example, the scholar may receive at least one week to complete the assignment 128, 130, 134. In some embodiments, the scholar database 106 at least partially limits the visibility of the scholar to donors or removes the scholar from a queue of potential recipients until the scholar completes the assignment 128, 130, 134. Once the assignment 128, 130, 134 is completed, the scholar database 106 may return the scholar to an ordinary position in the scholar database 106. If the scholar does not complete the assignment within the designated time, the scholar will not receive the scholarship and the donor will be notified. The donor may then select to offer the scholarship to a different scholar.

The payment module 108 is configured to receive payment from the donor to fund the scholarship. The payment module 108 is also configured to provide payment to the school when the task associated with the scholarship has been completed and the payment module 108 receives donor input that verifies completion. In some embodiments, the payment module 108 may be incorporated into another component of the system 100 such as the donor interface 102. In other embodiments, the payment module 108 may be separate from the interfaces. For example, the payment module 108 may be provided by a third party website that is linked to the donor interface 102 and to other components of the system 100. The payment module 108 is configured to securely receive financial information such as payment card information and/or bank accounts and use the secure information to route payments. The payment module 108 may store information on the scholarships, the funds deposited in the scholarship, payment information, and any other relevant information. In some embodiments, the secure information may be stored on a separate database. In some embodiments, a banking interface 109 is provided to facilitate the transfer of funds between the payment module 108 and the school. For example, the banking interface 109 includes bank accounts that hold the funds between funding the scholarship and transfer to the school accounts. In addition, the banking interface 109 may include services that allow for the secure transfer between accounts. In some embodiments, the payment module 108 and the banking interface 109 are incorporated in one or more financial structures. The payment module 108 or the banking interface 109 may be configured to release funds for the scholarship when the donor certifies that the assignment 128, 130, 134 has been completed. In some embodiments, payments may be automatically sent to the school when the funds are released. In other embodiments, a user may release and/or provide payments to the school. In the example, the entire amount of the scholarship is provided to the school as payment for a tuition account of the scholar.

In preferred forms, the scholar and the scholar's guardians do not receive any direct payment from a scholarship. The payments for scholarships from the donors are provided to the school and the school credits the scholar's tuition account to ensure the funds are applied directly to education expenses. If there is an overpayment or other conflict, the funds for the scholarship may be returned to the donor but will not be given to the scholar or the scholar's guardians. The scholar's guardians are responsible for the tuition to the school. The administrators of the system 100 and the donors do not have any responsibility or obligation for a scholar's tuition. Nor is the scholar's tuition guaranteed to be paid by scholarships merely because of the scholar's inclusion in the scholar database 106. Rather, the scholar and the scholar's guardians are encouraged to take responsibility and earn scholarships for the tuition. To protect the financial integrity of the platform, scholars, parents, and/or guardians do not receive funds directly and all scholarships are applied to the tuition account of the scholar at the participating school.

FIGS. 2 and 3 show a website 116 for use with the system 100. The website 116 allows users, including donors, scholars, guardians, school representatives, and interested parties, to access and utilize the system 100. In particular, the website 116 includes links to the donor interface 102, the scholar/guardian interface 112, and the school interface 110. In addition, the website 116 contains additional information about the system 100 to allow users of the website 116 to learn the history and mission of the micro-scholarship and interactive learning program embodied by the system 100. For example, the website 116 may include links titled “How it Works”, “Donors”, “Parents”, “Schools”, “About Us”, “Blog”, “Frequently Asked Questions”, “Contact Us”, and “The Founder's Story”. The links and any associated interfaces may be accessible in drop-down menus such as menu 136 extending across the top of the website 116. In addition, the links and any associated interfaces may be accessible by scrolling down on the website 116 to reveal a menu 138. In alternative embodiments, the website 116 may have any suitable arrangement of menus and/or links.

The website 116 may include graphics configured to attract the user and/or inform the user about the program. In some embodiments, information about scholars from the scholar database 106 (shown in FIG. 1) may be provided in the graphics. For example, the web site 116 may include images and/or videos of one or more scholars.

With reference to FIGS. 1-3, the system 100 allows a donor to generate and provide a scholarship to a scholar chosen by the donor. For example, a donor may access the donor interface 102 via the website 116. The donor may then browse through scholars in the scholar database 106 using the donor interface 102. For example the donor may enter search criteria and the donor interface 102 displays a list of scholars matching the criteria. The donor may sort the list of scholars and view information about the scholars such as pictures, videos, age, sex, race, religion, school, location of residence, family situation, financial need, duration of inclusion in the scholar database, participation in the scholar database, received scholarships, tuition needs, extracurricular interests, educational scores, and educational goals. The donor selects at least one scholar using the donor interface 102. In some embodiments, the donor may choose to have the system 100 select the scholar.

The donor may generate a scholarship for the selected scholar using the donor interface 102. For example, the donor may select the amount of the scholarship and how the scholarship will be applied. The donor may input payment information using one of the donor interface 102 and the payment module 108 and the payment module will record that the scholarship has been funded. The donor may also input information and/or a message for the scholar. Also, the donor may relate at least one assignment 128, 130, 134 to the scholarship.

The scholar may receive a notification such as an electronic message, text message, and/or phone call when a donor has provided a scholarship for the scholar. The scholar may then have a designated period of time to complete the assignment 128, 130, 134 associated with the scholarship. The scholar and/or a guardian of the scholar may use the scholar interface 112 to complete the assignment 128, 130, 134. The assignment 128, 130, 134 may include a video and a quiz. Once the assignment is completed, the donor receives a notification and may be provided an opportunity to review the quiz completed by the scholar and/or guardian. The donor may certify that the assignment is complete or mark that the assignment is incomplete within a designated time. When the assignment is complete and the donor has certified completion, the payment module will release the funds for the scholarship and payment will be provided to the school.

Embodiments described above allow scholars to earn scholarships from donors and facilitate the scholars attending schools they might not otherwise be able to afford. In addition, the system allows donors to assign a task to the scholars and/or the guardians of the scholars for completion before receiving the scholarship. The task may be related to a specific topic selected by the donor and provide a lesson to the scholar and/or guardian that the donor feels is valuable. In addition, the donors may receive tangible results for their donation such as a report on the scholars' assignments. Accordingly, the scholars are accountable to the donors.

In addition, the system 100 may allow private schools to receive additional financial support and may improve the resources available to the private schools. As a result, the described embodiments may allow private schools to establish new practices that diverge from established norms in the education field. For example, in some embodiments, the schools may utilize teachers that receive training through career and life experiences rather than in an educational setting. Such teachers can be considered “citizen teachers” as they are representative members of the community and are not necessarily trained to teach in a classroom. The citizen teachers may allow scholars to interact and learn from professionals and individuals in jobs that may interest the scholars. In addition, the citizen teachers may allow schools to reduce costs because the schools may be able to reduce the size and/or cost of teaching staff. Also, the student populations at the private schools may be more diverse than if some scholars were precluded from attending the private schools due to the cost of tuition.

As various changes could be made in the above constructions without departing from the scope of the invention, it is intended that all matter contained in the above description and shown in the accompanying drawings shall be interpreted as illustrative and not in a limiting sense. Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system for managing scholarships, said system comprising:
a database including scholars, wherein each scholar is associated with a school using a student identification number;
a donor interface configured to:
display a list of scholars from the database based on criteria selected by a donor;
select at least one of the scholars; and
generate a scholarship for the selected scholar, wherein an amount of the scholarship is associated with a task, wherein the task relates to a topic selected by the donor; and
a payment module configured to:
receive payment from the donor to fund the scholarship; and
provide payment to the school when the task associated with the scholarship has been completed.

2. The system of claim 1, wherein the task is selected from a curriculum, wherein the curriculum includes at least one of life skills, career training, and moral values.

3. The system of claim 2 further comprising a scholar interface configured to allow at least one of the scholar and a guardian of the scholar to complete the task.

4. The system of claim 3, wherein the scholar interface and the donor interface are accessible on a website.

5. The system of claim 1, wherein the task comprises at least one of watching a video and reading literature.

6. The system of claim 1, wherein the donor interface is further configured to provide a report to the donor when the task associated with the scholarship has been completed.

7. The system of claim 6, wherein the donor interface is configured to receive donor input relating to the completed task.

8. The system of claim 7, further comprising a scholar interface configured to provide the donor input to the scholar.

9. The system of claim 7, wherein the payment module is configured to receive the donor input relating to the completed task prior to providing the payment to the school.

10. A method for managing scholarships, said method comprising:
displaying a list of scholars from a database of scholars, wherein each scholar is associated with a school;
selecting, using a donor interface, at least one scholar from the database of scholars;
generating a scholarship for the selected scholar, wherein an amount of the scholarship is selected by a donor;
receiving, using a payment module, payment from the donor to fund the scholarship;
associating a task with the scholarship, wherein the task relates to a topic selected by the donor; and
providing payment to the school when the task associated with the scholarship has been completed.

11. The method of claim 10 further comprising selecting the task from a curriculum, wherein the curriculum includes at least one of life skills, career training, and moral values.

12. The method of claim 11 further comprising completing the task using a scholar interface configured to allow at least one of the scholar and a guardian of the scholar to complete the task.

13. The method of claim 12 further comprising accessing at least one of the scholar interface and the donor interface on a website.

14. The method of claim 10 further comprising completing the task using a scholar interface, wherein the task comprises at least one of watching a video and reading literature.

15. The method of claim 10 further comprising providing, using the donor interface, a report to the donor when the task associated with the scholarship has been completed.

16. The method of claim 15 further comprising receiving, using the donor interface, donor input relating to the completed task.

17. The method of claim 16 further comprising providing, using a scholar interface, the donor input to the scholar.

18. The method of claim 16 further comprising sending the donor input to the payment module, wherein the payment module is configured to receive the donor input relating to the completed task prior to providing the payment to the school.

19. A method for creating a scholarship, said method comprising:
selecting a student from a database of pre-qualified students using a donor interface containing at least one photograph and information relating to each student, wherein the database associates each scholar with a school and a student identification number;
selecting an accountability task from a list of topics using the donor interface, each accountability task is associated with a scholarship amount;
funding the scholarship amount using a payment module;
associating the scholarship with the student identification number and with the completion of the accountability task;
providing the accountability task to a family of the selected scholar using a scholar interface, wherein the scholar interface provides a due date for completion of the accountability task and wherein the family of the selected scholar is required to complete a quiz associated with the accountability task; and
notifying the donor upon completion of the accountability task, wherein the donor is allowed to provide feedback including a review and a rating;
depositing, using a banking interface, scholarship funds in an account associated with the school; and
associating the deposited funds with the student identification number using the banking interface.

20. The method of claim 19 further comprising receiving, using the donor interface, certification from the donor that the family of the selected scholar has completed the accountability task, wherein the banking interface is configured to deposit the scholarship funds in the account associated with the school after the donor interface receives certification from the donor.
